(19) United States
(12) Patent Application Publication
(10) Pub. No.: US 2015/0170538 A1
(43) Pub. Date: Jun. 18, 2015

(54) SYSTEM AND METHOD FOR ADAPTING THE DELIVERY OF INFORMATION TO PATIENTS

(71) Applicant: KONINKLIJKE PHILIPS N.V., Eindhoven (NL)

(72) Inventors: Paul Anthony Shrubsole, Gelderland (GB); Ronald Leo Christiaan Koymans, Eindhoven (NL); Juliana Pauline Kelly, Best (NL); Marieke Van Dooren, Arendonk (BE)

(21) Appl. No.: 14/558,856

(22) Filed: Dec. 3, 2014

(30) Foreign Application Priority Data
Dec. 13, 2013 (EP) 13197086.5

(51) Int. Cl. G09B 7/00; G09B 19/00

(52) U.S. Cl. CPC G09B 7/00; G09B 19/00

(57) ABSTRACT

The present invention provides a system for adapting the delivery of information to a user, the system comprising: an information receiving mechanism arranged to receive patient information comprising a plurality of information units and at least one sequence for delivering the plurality of information units to the user, wherein each information unit is at least one of instructional and informational information, and in the sequence each information unit is associated with at least one of a time window for delivering the information unit and a priority score representing the priority for delivering the information unit; an information delivering mechanism arranged to deliver a first information unit in a first sequence to the user via a delivery platform; a feedback receiving mechanism arranged to receive feedback corresponding to the delivered information unit; a feedback evaluation mechanism arranged to calculate a feedback score for the received feedback; a processing mechanism arranged to compare the feedback score with a predetermined threshold, wherein if the feedback score is lower than the predetermined threshold, an adjustment mechanism is arranged to adjust at least one of a time window, score, and delivery platform of the first delivered information unit based on a result of the comparison and the information delivering mechanism is arranged to deliver the adjusted first information unit, and if the feedback score is equal to or higher than the predetermined threshold, the information delivering mechanism is arranged to deliver a next information unit in the first sequence.

### CROSS-REFERENCE TO PRIOR APPLICATIONS

This application claims the benefit of European Patent Application No. 13197086.5, filed on Dec. 13, 2014 and is incorporated by reference herein.

### FIELD OF THE INVENTION

The present invention relates to a system and a corresponding method to adaptively dose information to patients. In particular, the present invention involves a method that adaptively tailors an educational program for patients within the hospital setting and their transition to home.

### BACKGROUND OF THE INVENTION

For patients with chronic ailments, the transition from hospital to home is difficult. Many patients tend to get readmitted to hospital shortly after discharge, due to the lack of adherence to their discharge instructions. As a consequence, this places a large burden on healthcare systems.

There are several causes for this problem. Firstly, current practices do not sufficiently provide the patient with information and education to self-manage their condition in a way that is tailored to their needs. Secondly, healthcare systems do not have the resources to provide a sufficient support network outside of the hospital. Thirdly, when asked, nearly all patients prefer to stay at home during their treatment. It is therefore in the interests of all parties to improve self-management solutions beyond the state of the art.

Conventional systems relate to adherence aspects with respect to clinical treatments, but do not take into account the ability for the patient to absorb information during the said treatments. Moreover, they do not take into account the critical aspects of transitions from hospital to home in the information tailoring process and how information about the patient can be gleaned and iterated from the hospital bed before the self-management program is rolled out in the patient's home.

Health literacy, cognition, and self-efficacy are important factors of successful understanding and execution of instructions of patients after hospital release. However, self-efficacy and cognitive ability are not constant during the discharge period, and individuals will have different experiences of recovery and relapse at different moments of their post-discharge therapy. This implies the need for a method to identify patients at risk for poor understanding and execution of hospital discharge instructions, and to provide customized approaches to meet them at their respective levels adaptively over a period of time.

Given the complexity of the above identified problem and the limits of health-care provisioning resources, customization of approaches are difficult to achieve. Therefore, a semi-automated approach is required.

### SUMMARY OF THE INVENTION

It is an object of the invention to provide a system and method which substantially alleviates or overcomes the problems mentioned above. In particular, the present invention provides a recovery pathway planning system for the modularization of the recovery pathway of a patient, which takes into account the time spent in the hospital as well as the time the patient spends at home after hospital discharge.

According to an aspect of the present invention, there is provided a system for adapting the delivery of information to a user, the system comprising: an information receiving mechanism arranged to receive patient information comprising a plurality of information units and at least one sequence for delivering the plurality of information units to the user, wherein each information unit is at least one of instructional and informational information, and in the sequence each information unit is associated with at least one of a time window for delivering the information unit and a priority score representing the priority for delivering the information unit; an information delivering mechanism arranged to deliver a first information unit in a first sequence to the user via a delivery platform; a feedback receiving mechanism arranged to receive feedback corresponding to the delivered information unit; a feedback evaluation mechanism arranged to calculate a feedback score for the received feedback; a processing mechanism arranged to compare the feedback score with a predetermined threshold, wherein: if the feedback score is lower than the predetermined threshold, an adjustment mechanism is arranged to adjust at least one of a time window, score, and delivery platform of the first delivered information unit based on a result of the comparison and the information delivering mechanism is arranged to deliver the adjusted first information unit, and if the feedback score is equal to or higher than the predetermined threshold, the information delivering mechanism is arranged to deliver a next information unit in the first sequence.

The sequence may form a “trajectory” of patient information units, e.g. progressively including more or more detailed information. The information units in the sequence may be of the same type (e.g. providing progressively more detail on a topic) or may be linked (e.g. it may be desirable to provide information A before information B in sequence).

If the feedback score is lower than the predetermined threshold, then the associated parameters (e.g. time window and delivery platform) will be adjusted and that information unit will be delivered again before the next one in the sequence. This helps to ensure that that user understands the instruction or information in the information unit before the next information unit (e.g. containing a more detailed instruction or set of information) is delivered.

Such embodiments of the present invention allow the information load to the user to be increased or decreased according to periodic checks and flagged semi-automated measures of the user using subjective and objective data (with potentially self-learning behavior) with modifications to parameters of the plurality of information units (e.g. duration).

Specifically, a sequence may be based on at least one of information contained in the received patient information, instructions provided by a physician, and information provided by the user. The sequence may also be a sequence received from an external source at the information receiving mechanism. Information about the user, and information about the user's current ailment(s) may serve as later input for tailoring discharge instructions, i.e. at least one of the plurality of information units to be delivered to the user.

Hence, the adjustment mechanism is arranged to adjust at least one of a time window, a score, and a delivery platform associated with the delivered information unit based on a result of the evaluation and comparison performed at the feedback evaluation mechanism. The initial defined set of information units and their associated parameters may be refined by adjusting one of: the pace that information or instruction is being delivered to the user, the time for delivering information or instruction to the user, the score of priority assigned to a certain unit information unit. The adjustment mechanism may perform the adjustments by taking into account of factors relating to the absorption-level of the user.

Factors relating to the absorption-level of the user may change over time due to various reasons (especially moments that potentially trigger a relapse in the patient's condition) and these factors also serve as input to dynamically determine the new trajectory including the unit of information, the style of information and the moment of information delivery.

The method provided by some embodiments of the present invention allows information load to the user to be increased or decreased according to periodic checks and flagged semi-automated measures of the user using subjective and objective data (with potentially self-learning behavior) with modifications to parameters of the plurality of information units (e.g. duration).

The terms “instructional information” and “informational information” relate to all types of information that could be needed/desired by the patient, and can include all types of patient information, including information such as introductions, health care information, recommendations, coaching, etc.

In some embodiments, if the feedback score is lower than the predetermined threshold, the information delivering mechanism is arranged to deliver a previous information unit in the first sequence. In such embodiments, if the system determines that the user has passed too quickly down the sequence (e.g. based on very low feedback scores), the user can be given the chance to recap the previous information units. This would be useful if, for example, the user has had a worsening in their condition.

In some embodiments, the received patient information comprises a plurality of sequences for delivering information units, and the information delivering mechanism is arranged to deliver a second information unit in a second sequence via a second delivery platform, further wherein the priority scores associated with the first information unit and the second information unit are used to determine the priority for delivering the first information unit and the second information unit.

In some embodiments, the predetermined threshold is a reference score associated with the received feedback. In such embodiments, since the reference score may be a de facto score then a comparison can be easily made in the system.

In some embodiments, the adjusting at least one of a time window, priority score, and delivery platform the delivered information unit is based on a difference between the feedback score and the predetermined threshold.

In some embodiments, the priority score is calculated based on the at least one of a complexity of the information unit, a cognitive difficulty of the user to understand the instructional or informational information of the information unit and a physical difficulty of the user for following the instructional information of the information unit.

In some embodiments, the priority score of each of the information units in each of the sequences is calculated based on the at least one of a relative complexity of the information unit among all information units in the sequences, a relative cognitive difficulty for the user to understand the instructional or informational information of the information unit among all the information units in the sequences, and a relative physical difficulty of the user for following the instructional information of the information unit among all the information units in the sequences. In addition to taking into account the importance of the information unit the present invention also takes into account the complexity and difficult of the information unit to provide more accurate tailoring of the information content to the user.

In some embodiments, the priority score for delivering the information unit is taken into account when determining at least one of: when the information is delivered, how the information is delivered, and importance of the informational or instructional information of the information unit.

For example, if the priority score is high, the system may be arranged to deliver the information unit via a more effective platform or deliver the information unit more frequently, and how the rest of the information units would be affected in terms of their scores/time window/delivery platform if this particular information unit is not delivered/absorbed.

In some embodiments, the information delivering mechanism is arranged to deliver the first information unit according to at least one of the time window, the score, and the delivery platform associated with the first information unit.

In some embodiments, the delivery platform is at least one of: a textual delivery platform, an audio delivery platform, a video delivery platform, an interactive e-learning platform, a reminder scheduling platform, a tablet computer, a Smartphone, paper, voice, face-to-face and video-chat.

In some embodiments, the feedback contains information relating to at least one of: medical data of the user, recommended treatment for the user, interaction data between the user and a healthcare provider, an attention level of the user required to process the delivered information unit, a time period the user required to process the delivered information unit, concentration level of the user, cognitive level of the user, lifestyle preference of the user, personal preference of the use, cultural needs of the user, emotional needs of the user, social needs of the user, health literacy of the user, medical history of the user, psychological state of the user, emotional state of the user, readmission history of the user, location of the user.

In some embodiments, the feedback is one of: time data, eye-tracking data indicative of at least one of the user's focus on an area of the delivered information unit or delivery platform and the amount of time the user looks at an area of the delivered information unit or delivery platform, page scroll data, frequency with which a delivery platform is used, gyroscope data of a delivery platform, accelerometer data of a delivery platform, data provided by the user in a form, data provided by the user in a questionnaire, data provided by the user in a randomized quiz, and data provided by the user via a web-based application.

In some embodiments, the feedback is received from at least one of: manually entered information from the user, manually entered information from a physician, an eye-tracking device, a camera, a weighing scale, an accelerometer, a gyroscope, a web browser.

In some embodiments, the received feedback is compared against reference data in order to obtain the feedback score. For example, data received from eye-tracking device could be compared to stored reference data in order to determine if the received eye-tracking data matches a pattern. Comparing received data with reference data in this way could be used for a number of different types of feedback data.

In some embodiments, the form, questionnaire, randomized quiz, or web-based application associated with the delivered information unit is designed based on at least one of a time window, delivery platform, and priority score of at least one of the information units in the sequence.

In some embodiments, the evaluating of the feedback score is based on at least one of a: preference of the user to the delivery platform; a percentage of correct answers in a randomized quiz, time taken to read a page of information before it is changed, information provided by a health care professional associated with the delivery of the first information unit, sensor data associated with the delivery of the first information unit.

In some embodiments, the patient information is at least one of: an education package, an admission reason, a discharge diagnosis, a pending medical test, a result of a medical test, a result of a surgery, a procedure of a surgery, a required medical test, a required blood test, a referral to other agency or service, a list of medications, a dosage of a medication, a time of a medication, a frequency of a medication, a prescription, an order pain medication, a pain management instruction, a follow-up medical appointment, an activity restriction, a diet instruction, a weight monitoring instruction, a fluid intake instruction, wound care information, a sign of infection, a condition to call a physician, a condition to return to a hospital, a discharge video, and a medical instruction.

In some embodiments, the user is recovering from a health condition is, the system further comprising: a monitor mechanism arranged determine recovery parameters relating to treatments received by the user, the recovery parameters being indicative of the progress of the user's recovery; an discharge planning mechanism arranged to determine a discharge plan for the user based on the recovery parameters, the discharge plan comprising said plurality of information units.

According to another aspect of the present invention, there is provided a method for adapting the delivery of information to a user, the method comprising: receiving patient information comprising a plurality of information units and at least one sequence for delivering the plurality of information units to the user, wherein each information unit is at least one of instructional and informational information, and in the sequence each information unit is associated with at least one of a time window for delivering the information unit and a priority score representing the priority for delivering the information unit; delivering a first information unit in a first sequence to the user via a first delivery platform; receiving feedback corresponding to the delivered information unit; evaluating a feedback score for the received feedback; comparing the feedback score with a predetermined threshold; and if the feedback score is lower than the predetermined threshold, adjusting at least one of a time window, priority score, and delivery platform of the delivered first information unit based on a result of the comparison and delivering the adjusted first information unit, or if the feedback score is equal to or higher than the predetermined threshold, delivering a next information unit in the first sequence.

In some embodiments, the received patient information comprises a plurality of sequences for delivering information units, and the method further comprises delivering a second information unit in a second sequence via a second delivery platform, further wherein the priority scores associated with the first information unit and the second information unit are used to determine the priority for delivering the first information unit and the second information unit.

In some embodiments, the predetermined threshold is a reference score associated with the received feedback.

In some embodiments, the adjusting at least one of a time window, priority score, and delivery platform the delivered information unit is based on a difference between the feedback score and the predetermined threshold.

In some embodiments, the priority score is calculated based on the at least one of a complexity of the information unit, a cognitive difficulty of the user to understand the instructional or informational information of the information unit and a physical difficulty of the user for following the instructional information of the information unit.

In some embodiments, the priority score of each of the information units in each of the sequences is calculated based on the at least one of a relative complexity of the information unit among all information units in the sequences, a relative cognitive difficulty for the user to understand the instructional or informational information of the information unit among all the information units in the sequences, and a relative physical difficulty of the user for following the instructional information of the information unit among all the information units in the sequences.

In some embodiments, the priority score for delivering the information unit is taken into account when determining at least one of: when the information is delivered, how the information is delivered, and importance of the informational or instructional information of the information unit.

In some embodiments, the delivering of the information unit is according to at least one of the time window, the score, and the delivery platform associated with the information unit.

In some embodiments, the delivery platform is at least one of: a textual delivery platform, an audio delivery platform, a video delivery platform, an interactive e-learning platform, a reminder scheduling platform, a tablet computer, a Smartphone, paper, voice, face-to-face and video-chat.

In some embodiments, the feedback contains information relating to at least one of: medical data of the user, recommended treatment for the user, interaction data between the user and a healthcare provider, an attention level of the user required to process the delivered information unit, a time period the user required to process the delivered information unit, concentration level of the user, cognitive level of the user, lifestyle preference of the user, personal preference of the use, cultural needs of the user, emotional needs of the user, social needs of the user, health literacy of the user, medical history of the user, psychological state of the user, emotional state of the user, readmission history of the user, location of the user.

In some embodiments, the feedback is one of: time data, eye-tracking data indicative of at least one of the user's focus on an area of the delivered information unit or delivery platform and the amount of time the user looks at an area of the delivered information unit or delivery platform, page scroll data, frequency with which a delivery platform is used, gyroscope data of a delivery platform, accelerometer data of a delivery platform, data provided by the user in a form, data provided by the user in a questionnaire, data provided by the user in a randomized quiz, and data provided by the user via a web-based application.

In some embodiments, the feedback is received from at least one of: manually entered information from the user, manually entered information from a physician, an eye-tracking device, a camera, a weighing scale, an accelerometer, a gyroscope, a web browser

In some embodiments, the form, questionnaire, randomized quiz, or web-based application associated with the delivered information unit is designed based on at least one of a time window, delivery platform, and priority score of at least one of the information units in the sequence.

In some embodiments, the evaluating of the feedback score is according to at least one of a: preference of the user to the delivery platform; a percentage of correct answers in a randomized quiz, the time taken to read a page of information on a tablet device before it is changed, the outcome of executing a particular instruction as evaluated by a health care professional or by sensors linked to the processes and their outcome.

In some embodiments, the patient information is at least one of: an education package, an admission reason, a discharge diagnosis, a pending medical test, a result of a medical test, a result of a surgery, a procedure of a surgery, a required medical test, a required blood test, a referral to other agency or service, a list of medications, a dosage of a medication, a time of a medication, a frequency of a medication, a prescription, an order pain medication, a pain management instruction, a follow-up medical appointment, an activity restriction, a diet instruction, a weight monitoring instruction, a fluid intake instruction, wound care information, a sign of infection, a condition to call a physician, a condition to return to a hospital, a discharge video, and a medical instruction.

According to another aspect of the invention, there is provided a system for adapting the delivery of information to a user, the system comprising: an information receiving unit arranged to receive patient information comprising a plurality of information units and at least one sequence for delivering the plurality of information units to the user, wherein each information unit is at least one of instructional and informational information, and in the sequence each information unit is associated with at least one of a time window for delivering the information unit and a priority score representing the priority for delivering the information unit; an information delivering unit arranged to deliver a first information unit in a first sequence to the user via a delivery platform; a feedback receiving unit arranged to receive feedback corresponding to the delivered information unit; a feedback evaluation unit arranged to calculate a feedback score for the received feedback; a processing unit arranged to compare the feedback score with a predetermined threshold, wherein if the feedback score is lower than the predetermined threshold, an adjustment unit is arranged to adjust at least one of a time window, score, and delivery platform of the first delivered information unit based on a result of the comparison and the information delivering unit is arranged to deliver the adjusted first information unit, and if the feedback score is equal to or higher than the predetermined threshold, the information delivering unit is arranged to deliver a next information unit in the first sequence.

According to another aspect of the present invention, there is provided a system for adapting the delivery of information to a user, the system comprising: an information receiving mechanism arranged to receive patient information comprising a plurality of information units and at least one sequence for delivering the plurality of information units to the user, wherein each information unit is at least one of instructional and informational information; and in the sequence each information unit is associated with at least one of: an order of the information unit in the sequence, a priority score representing the priority for delivering the information unit, a presentation format for delivering the information unit, and a time window for delivering the information unit; a recovery parameter determination mechanism arranged to receive data related to a recovery parameter of the user; an evaluation mechanism arranged to determine whether adjustment is required for at least one of: an order, a priority score, a presentation format, and a time window of at least one of the plurality of information units, based on the data received by the recovery parameter determination mechanism; an adjustment mechanism arranged to perform an adjustment of at least one of: an order, a priority score, a presentation format, and a time window of at least one of the plurality of information units based on the results of the determination; and an information delivering mechanism arranged to deliver at least one of the plurality of information units according to at least one of its order, priority score, presentation format, and time window.

In some embodiments, the recovery parameter of the user may be at least one of: an effectiveness of a previously delivered information unit, a rate of improvement of the user, a side effect experienced by the user, physical mobility of the user, cognitive awareness of the user, an ability to process an information unit of the user, self-efficacy of the user, pain and/or discomfort experienced by the user, and sensitivity to relapse of the user.

According to another aspect of the present invention, there is provided a system for adapting the delivery of information to a patient recovering from a health condition, comprising: a monitor mechanism arranged determine recovery parameters relating to treatments received by the patient, the recovery parameters being indicative of the progress of the patient's recovery; an discharge planning mechanism arranged to determine a discharge plan for the patient based on the recovery parameters, the discharge plan comprising a plurality of information units and at least one sequence for delivering the plurality of information units to the user, wherein each information unit is at least one of instructional and informational information, and in the sequence each information unit is associated with at least one of a time window for delivering the information unit and a priority score representing the priority for delivering the information unit; a discharge plan delivering mechanism arranged to deliver a first information unit in a first sequence of the discharge plan to the user via a delivery platform; a feedback receiving mechanism arranged to receive feedback corresponding to the delivered information unit; a feedback evaluation mechanism arranged to calculate a feedback score for the received feedback; a processing mechanism arranged to compare the feedback score with a predetermined threshold, wherein if the feedback score is lower than the predetermined threshold, an adjustment mechanism is arranged to adjust at least one of a time window, score, and delivery platform of the first delivered information unit based on a result of the comparison and the information delivering mechanism is arranged to deliver the adjusted first information unit, and if the feedback score is equal to or higher than the predetermined threshold, the information delivering mechanism is arranged to deliver a next information unit in the first sequence.

In some embodiments, the recovery parameter of the user is at least one of: an effectiveness of a previously delivered information unit, a rate of improvement of the user, a side effect experienced by the user, physical mobility of the user, cognitive awareness of the user, an ability to process an information unit of the user, self-efficacy of the user, pain and/or discomfort experienced by the user, and sensitivity to relapse of the user.

These and other aspects of the invention will be apparent from and elucidated with reference to the embodiments described hereinafter.

### BRIEF DESCRIPTION OF THE DRAWINGS

Embodiments of the invention will now be described, by way of example only, with reference to the accompanying drawings, in which:

FIG. 1 schematically shows a system for adapting the delivery of information to a user according to an embodiment of the present invention;

FIG. 2 shows a flow diagram explaining the operation of the system of an embodiment of the present invention;

FIG. 3 shows a flow diagram explaining in detail the operation of evaluating the feedback score of a delivered information unit and comparing the feedback score with a predetermined threshold, according to an embodiment of the present invention;

FIG. 4 shows an example of patient information comprising a plurality of modularized information units according to an embodiment of the present invention;

FIG. 5 shows another example of patient information which is modularized into information units according to an embodiment of the present invention;

FIG. 6 shows another example of patient information which is modularized into information units according to an embodiment of the present invention;

FIG. 7 shows an example of a defined sequence comprising a plurality of information units to be delivered to a user, according to an embodiment of the present invention;

FIG. 8 shows a flow diagram explaining the operation of the system of an embodiment of the present invention; and

FIG. 9 schematically shows a system according to an embodiment of the present invention;

### DETAILED DESCRIPTION

Certain embodiments will now be described in greater detail with reference to the accompanying drawings. In the following description, like drawing reference numerals are used for like elements, even in different drawings. The matters defined in the description, such as detailed construction and elements, are provided to assist in a comprehensive understanding of the exemplary embodiments. However, the embodiments can be practiced without those specifically defined matters. Also, well known functions or constructions are not described in detail since they would obscure the embodiments with unnecessary detail. Moreover, expressions such as “at least one of”, when preceding a list of elements, modify the entire list of elements and do not modify the individual elements of the list. Unless features of “one embodiment” are inconsistent with features of other embodiments, the term “one embodiment” shall be construed to be a disclosure of the associated features in conjunction with all other features that are consistent therewith.

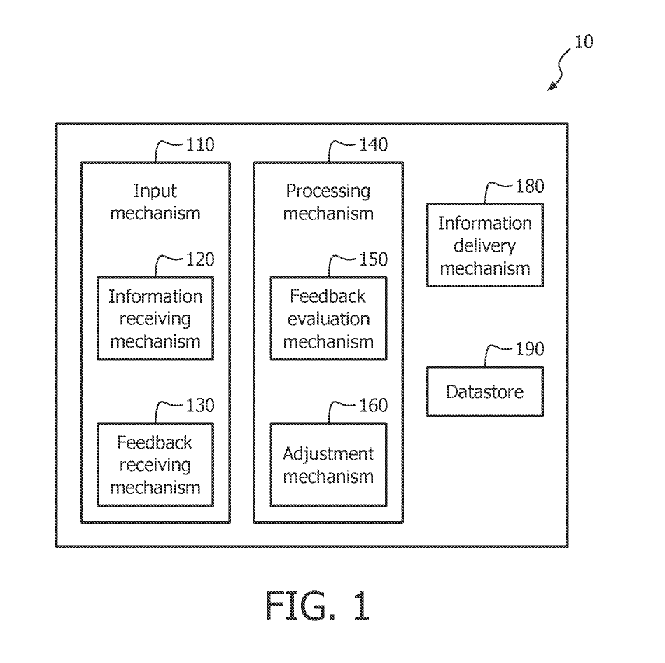

FIG. 1 schematically shows a system for adapting the delivery of information to a user according to an embodiment of the present invention.

In FIG. 1, system 10 comprises an input mechanism 10, an information receiving mechanism 120, a feedback receiving mechanism 130, a processing mechanism 140, a feedback evaluation mechanism 150, an adjustment mechanism 160, an information delivery unit 170, and a datastore 180. The various mechanisms (or units) can, in some embodiments, by provided by a single device (e.g. a single unit) or by a set of devices (e.g. a set of units).

The input mechanism 110 comprises the information receiving mechanism 120 and feedback receiving mechanism 130 in this particular embodiment. However, in other embodiments of the present invention, the information receiving mechanism 120 and feedback receiving mechanism 130 may be implemented separately, or integrated as a single information receiving mechanism.

The processing mechanism 140 comprises the feedback evaluation mechanism 150 and adjustment mechanism 160 in this particular embodiment. However, in other embodiments of the present invention, the feedback evaluation mechanism 150 and adjustment mechanism 160 may be implemented separately, or integrated as a single processing mechanism.

The information receiving mechanism 120 receives patient information. The patient information comprises a plurality of information units and at least one sequence for delivering the plurality of information units to the user, wherein each information unit is associated with at least one of instructional and informational information, and in the sequence each information unit is associated with at least one of a time window for delivering the information unit and a priority score representing the priority for delivering the information unit.

The patient information may comprise a plurality of information units to be delivered to the user during his stay at a hospital and/or during his recovery at home after being discharged from the hospital. Each information unit may be a modularized part of a course of treatment(s) tailored by a clinical professional.

The patient information may be derived from a medical status from a medical assessment performed by healthcare provider, e.g. a physician. The medical status may be assessed based on at least one of the following factors: patient medical data, recommended set of appropriate treatments within the hospital, factors of the user that relate to the information absorption-level.

Factors that relates to the information absorption-level of the user may include but not limited to: concentration level of the user, cognitive level of the user, lifestyle preferences of the user, personal preferences of the users, cultural needs of the user, emotional and social needs of the user, (health) literacy, and other measures that may influence absorption-level of the user. These factors may be derived from previous statistics of other patients suffering from the same or similar conditions.

The patient information may be derived according to a target group in which the user belongs, so as to increase the accuracy of the range of adaptation. For example, senior heart condition patients may have longer period of time associated for each informational unit and where certain units gain in severity (e.g. activity related units).

The patient information may be extracted from one of: an education package, an admission reason, a discharge diagnosis, a pending medical test, a result of a medical test, a result of a surgery, a procedure of a surgery, a required medical test, a required blood test, a referral to other agency or service, a list of medications, a dosage of a medication, a time of a medication, a frequency of a medication, a prescription, an order pain medication, pain management, a follow-up medical appointment, an activity restriction, a diet plan, a weight monitoring plan, a fluid requirement, wound care information, a sign of infection, a condition to call a physician, a condition to return to a hospital.

Each modularized instruction or piece of information, which may be derived from a medical status or extracted from an educational or teaching package (which may be considered as the received patient information), may be considered as an information unit. For example, in a heart failure patient discharge information there may be a piece of instruction for viewing a Sudden Cardiac Arrest (SCA) video. This piece of instruction would then be modularized as “view SCA video”, or denote by “SCA”.

Each information unit may be assigned with a category according to the nature of the instruction of information. For example, for a user who suffered from congestive heart failure, the categories to which information units are assigned may include:

### Congestive Heart Failure Education Packet (CHFE)

### Congestive Heart Failure Discharge Video (CHFD)

### Sudden Cardiac Arrest Video (SCA)

### Medication Instructions (MI)

### Activity Instructions (AI)

### Diet Instructions (DI)

### Weight Monitoring Instructions (WI)

### Fluid Intake Instructions (FI)

### Pain Management Instructions (PI)

As an example, if the instructional information of the information unit is “view SCA video”, the information unit would be denoted by “SCA”.

Each information unit is associated with at least one of: a time window for delivery the information unit, a priority score representing the priority for delivering the information unit, and a delivery platform. The time window, priority score, and delivery platform of a particular information unit may be comprised in the patient information or determined by system 10 or processing mechanism 140 of the system. The information units are arranged in sequences, as discussed below.

The time window associated with the information unit may be determined according to the period of time to which the information unit should be understood by the user according to accepted, de-facto limits in hospital admission periods. These values may be defined by a clinical expert and serve as a template for use during treatment, whereby adaptations are made to these time periods and the order with which units of information are delivered. Other sensor data and contextual information may also be used to determine the most appropriate time or time frame to deliver information or instruction to the user.

The priority score representing the priority for delivering the information unit (herein referred to as “priority score”) may be determined according to the sequence in which instructions or pieces of information should be provided to the user. The priority score may be representative of severity if the instruction is not followed or incorrectly followed. The priority score may be on a scale of 1 to 10, or other scales which would allow efficient calculation and evaluation. The priority score may be linked to the risk of fatality of the user. The priority score may be calculated based on at least one of: a complexity of the information unit, a cognitive difficulty for the user to understand at least one of instructional or informational information of the information unit, and a physical difficulty for the user to perform or follow the instructional information of the information unit.

The priority score may be taken into account in the evaluation of feedback and subsequently affect the adjustment of at least one of a time window, priority score, and delivery platform of one of the plurality of information units in a defined sequence. The priority score may be taken into account when determining at least one of: when the information is delivered, how the information is delivered, and the importance of the information and/or instructional information of the information unit. For example, if the priority score associated with a certain information unit in the sequence is high, the system 10 (or particularly the information delivery unit 180) may be arranged such that the information unit is delivered via a more effective and/or proactive platform and/or the information unit is delivered more frequently to the user.

In some embodiments of the present invention, the received patient information may contain a plurality of sequences for delivering information units to the user. In these embodiments, the priority scores associated with a first information unit in a first sequence and with a second information unit in a second sequence may be used to determine the priority for delivering the first information unit and the second information unit.

Moreover, in these embodiments, the priority score for each of the information units in each of the sequences may be calculated based on the at least one of: a relative complexity of the information unit among all information units in the sequences, a relative cognitive difficulty for the user to understand the instructional or informational information of the information unit among all the information units in the sequences, and a relative physical difficulty of the user for following the instructional information of the information unit among all the information units in the sequences.

In some embodiments, the sequence for delivering information unit may be pre-determined by a clinical professional in accordance to his/her tailored course of treatment(s).

The delivery platform for delivering the information unit may be determined based on one of: the assessed medical status, the information delivery mechanism available, and information and/or instruction to be given to the user, and the priority score associated with the information unit. The delivery platform may correspond to the information delivery unit 170 of system 10. In other words, in certain embodiments of the present invention, the information delivery unit 170 of system 10 may be the delivery platform used to deliver an information unit to the user. In other embodiments of the present invention, the information delivery unit 170 may be used to transmit an information unit to an external delivery platform for conveying an information unit to the user. The delivery platform may be the same for all information units of a same sequence. The delivery platform may be the same for all information units in the received patient information. The delivery platform may be different for each of the information unit in each of the sequences.

The information unit and its associated time window, score, and delivery platform may be denoted in the format of unit [time, score, platform]. Table 1 below illustrates a number of examples of information units denoted in the format of unit [time, score].

A sequence, which may be received as part of the patient information received at the input mechanism 110 or information receiving mechanism 120, contains at least a subset of the plurality of information units contained in the received patient information. In some embodiments, information units will be repeated in certain sequences to enable reinforcement of key aspects in the learning program that where a low absorption level is expected.

Alternatively, in another embodiment of the present invention, the processing mechanism 140 of the system 10 may define a sequence based on at least one of informational or instructions information contained in the received patient information, instructions provided by a physician, and information provided by the user. The sequence may also be a sequence received from an external source at the information receiving mechanism 120.

The sequence may form a “trajectory” of patient information units, e.g. progressively including more or more detailed information. The information units in the sequence may be of the same type (e.g. providing progressively more detail on a topic) or may be linked (e.g. it may be desirable to provide information A before information B in sequence).

A sequence of information units may be denoted in an exemplary format of “unit1[time, score, platform]→unit2[time, score, platform]→unit3[time, score, platform]”. This particular example indicates that a first information unit (unit1) is to be delivered first, followed by the second information unit (unit2) and third information unit (unit3) subsequently, depending on their time window, priority score, and delivery platform.

Table 1 shows a number of examples of defined sequences for delivering information units to a user.

TABLE 1

| Example | Defined sequence |
|---|---|
| 1 | SCA2[0.5 hr, 7/10] → CHFE[0.5 hr, 8/10] → |
| | CHFE2[0.2 hr, 9/10] → CHFE4[1 hr, 4/10] |
| 2 | CHFE3[3 hrs: 5/10] |
| 3 | CHFE5[1 hr: 10/10] → MI1[0.5 hr: 10/10] |
| 4 | MI2[0.5 hr: 7/10] |
| 5 | SCA1[0.5 hr, 3/10] → PI1[0.5 hr, 6/10] → |
| | AI3[0.25 hr, 8/10] |

Examples 1 to 5 of Table 1 illustrate five different defined sequences for delivering certain selected information units to a certain user. In this example, instructions and pieces of information have been extracted from patient information, i.e. a heart failure patient education packet, and these are then modularized into a plurality of information units, either externally or by system 10 or processing mechanism 140 of the present invention. These information units are denoted as: SCA1 (first Sudden Cardiac Arrest Video), SCA2 (second Sudden Cardiac Arrest Video), CHFE (a first part of a Congestive Heart Failure Education package), CHFE2 (a second part of a Congestive Heart Failure Education package), CHFE3 (a third part of a Congestive Heart Failure Education package), CHFE4 (a fourth part of a Congestive Heart Failure Education package), CHFE5 (a fifth part of a Congestive Heart Failure Education package), MI1 (a first medical instruction), MI2 (a second medical instruction), PI1 (a first pain management instruction), AI3 (a third activity instruction).

In Example 1, the sequence comprises a number of modularized information units including the first Sudden Cardiac Arrest Video, a first part of a Congestive Heart Failure Education (CHFE) package, a second part of the Congestive Heart Failure Education (CHFE2) package, and a fourth part of the Congestive Heart Failure Education (CHFE4) package. The accepted, de-facto limit for understanding the first Sudden Cardiac Arrest Video (SCA2) in this example is 0.5 hour and the score representing the priority for delivering the video is 7/10. Therefore, the first part of the set of information units is defined as SCA2[0.5 hr, 7/10]. The rest of the information units are similarly defined accordingly to their respective limit for the user to understand and/or absorb the information unit and the priority score representing the priority for delivering the information unit. In some embodiments, the “de-facto limit” can be fine-tuned by self-learning to determine what adjustments to the time match the characteristics of previous patients.

In Example 1, it has been determined initially that the sequence for delivering the information units is first the SCA video, then the first, second, and fourth CHFE package. Therefore the sequence of information units in Example 1 is defined in this particular order which is represented by arrows.

In Example 3, the sequence of information units is identified as the most critical, because both the CHFE5 score and the MI1 score is 10/10. This means that more time should be allocated and/or other (lower priority-scored) information units should be dropped if the patient has relatively greater difficulty following these instructions. The information delivery unit 170 is arranged to deliver an information unit.

The information delivery unit 170 may be adapted to be capable of at least one of: textual delivery, audio delivery, video delivery, touch tablet, interactive e-learning, and reminder scheduler. The delivery platform for a certain information unit may be selected based on one of: the assessed medical status, the information delivery mechanism available, information provided by a physician, information provided by the user, and information and/or instruction to be given to the user.

The feedback receiving mechanism 130 is arranged to receive feedback corresponding to the delivered information unit. The feedback may be received directly from the user or from a data source. The data source may be connected to the feedback receiving mechanism 130. The feedback may be data related to at least one of the attention and time of the user takes to process an information unit. The feedback receiving mechanism 130 may be realized as an attention-span monitor, a user interface, or an adaptive learning test, e.g. questionnaire. In particular, the user interface may allow the user to express how they feel during and after the delivery of information unit(s). The feedback receiving mechanism 130 could be one or more sensors arranged to monitor the user. Such sensors could be, for example, an eye-tracking device, a camera, a weighing scale, an accelerometer, a gyroscope.

The feedback received at the feedback receiving mechanism 130 or the input mechanism 100 may be at least one of: sensor data, time data, eye-tracking data, page scroll data, frequency with which a delivery platform is used, gyroscope data of a delivery platform, and accelerometer data of a delivery platform. The eye-tracking data may be indicative of at least one of the user's focus on an area of the delivered information unit, and the user's focus on an area of the delivery platform (e.g. an area of the screen of a tablet), and the amount of time the user spends looking at a certain page or an area of the delivered information unit or delivery platform. The sensor data may be indicative of the physical mobility of the user, and the sensor(s) may be attached in the environment of the user to track relevant parameters.

The feedback may be indicative of the effectiveness and rate of improvement of the user with respect to the delivered information unit. The feedback may provide an indication of any side effect(s) experienced by the user in relation to the delivered information unit, including any reported pain and/or discomfort. The feedback may also be indicative of: the cognitive awareness and ability to process instructions of the user in relation to self-monitoring and self-treatment, self-efficacy of the user, and the user's sensitivity and/or likelihood to relapse.

The feedback may be received from, for example, at least one of: manually entered information from the user, manually entered information from a physician, an eye-tracking device, a camera, a weighing scale, an accelerometer, a gyroscope, a web-browser, a web-based application. The feedback may be received from a health-monitoring device that is connected to the input 110 or information receiving mechanism 120 of system 10.

For example, subjective and objective data about the information-absorption level of the user may be obtained via an attention-span monitor and adaptive learning test, etc. The feedback may be a user response to a question contained in a set of interactive instructions or a questionnaire or a form or a randomized quiz or a web-based application. Whilst in the hospital, such measurements can be reliably taken and can serve as predictor for possible future events that may influence absorption (e.g. based on a statistical model developed over time).

The adaptive learning test, interactive instructions, questionnaire, form, randomized quiz, etc. may be designed based on at least one of: a priority score representing the priority for delivering one of the information units in the sequence, information provided by a physician, information provided by the user, and previously received feedback data at the system. The adaptive learning test, interactive instructions, questionnaire, form, randomized quiz, etc. may be received from an external source at information receiving mechanism 120. The adaptive learning test, interactive instructions, questionnaire, form, randomized quiz, etc. may be stored in datastore 190.

The level of digestion/understanding of information during the delivering of information and/or instruction may be measured. This may be measured by talk-back, health-literacy, etc.

The attention of the user while they are receiving information or instructions may be monitored via eye-tracking via a front-facing camera of the information delivery mechanism. For example, the information delivery mechanism may be a tablet computer with a front-facing camera which tracks the eye movement of the user while the user is receiving information or an instruction.

The attention of the user while they are receiving information or instructions may also be monitored by measuring at least one of: the time taken by the user between page scrolls, the frequency with which the information delivery mechanism (e.g. tablet computer) is used, the motion and/or orientation of the information delivery mechanism (e.g. tablet computer) whilst being used (e.g. using gyroscope and/or accelerometer).

The feedback may also contain information from a follow-up information session held by a healthcare provider with the user regarding the transition from hospital to home. An example of feedback from such session would be the user's needs and home environment and whether he or she is more receptive to information that is personally conveyed and discussed.

The feedback evaluation mechanism 150 evaluates a feedback score for the delivered information unit. The feedback received at the feedback receiving mechanism 130 or input mechanism 110 is used to evaluate the number of parameters associated with the delivered information unit so as to optimize when and/or how the information unit is delivered to the unit and tailor the selection of delivery platform used for delivering information or instruction to the user. Specifically, the feedback evaluation mechanism 150 is arranged to perform evaluation based on efficacy statistics.

The statistics are gathered over time by evaluating/estimating the outcome of the consumption of a particular informational unit and the sequence that it is a part of. Different informational units will expect different outcomes, but all of them share core efficacy characteristics, namely the time taken to sufficiently understand the information and the time taken to execute the actions that instructional content prescribes for a given delivery platform. The distribution of a population having similar characteristics (e.g. demographics, medical profile) serves as an indicator of whether to adjust the metrics associated with the informational units. In the former case, the time and level of understanding can be compared to a reference to determine the relative efficacy. In the latter case, feedback evaluation will require the use of additional sensors to quantify the relative efficacy, for example in the case of a weight management instruction, a weighing scale that can wirelessly report when the patient uses the scale and the value of the scale will determine relative efficacy of performing the action according to a statistical baseline for a positive health outcome. Additional metrics that relate to health outcomes can be self-reported by the user using a quality of life questionnaire, by health professionals or by health insurance agencies. The statistics are collected for many patients, meaning that a new baseline and time allocation is determined if the distribution is skewed too far away (defined by a threshold metric indicating the degree of skew) from the initial reference provided in order to provide a more realistic outcome of the informational delivery system according to a particular priority for its delivery.

The efficacy statistics may be stored at datastore 180 for future improvement in performance of the tailoring of the initial defined set of information units for subsequent users.

The feedback received at input mechanism 110 or feedback receiving mechanism 130 may be used for evaluating a feedback score associated with the particular delivered information unit. The evaluation of the feedback score may be performed according to the nature of the received feedback. The evaluation of the feedback score may be based on a predetermined scale. Datastore 190 may store algorithms for the quantization from feedback data into a feedback score.

A feedback score may be calculated based on, for example, at least one of: a preference of the user for a delivery platform, a percentage of correct answers in a randomized quiz, the time taken to read a page of information on a tablet device before it is changed, the outcome of executing a particular instruction as evaluated by a health care professional or by sensors linked to the processes and their outcomes.

The feedback score of the delivered information unit may then be compared against a predetermined threshold in order to determine the efficacy of the delivered information unit and whether at least one of a time window, priority score, and delivery platform associated with the delivered information unit in the sequence requires adjustment. Specifically, if the feedback score is lower than the predetermined threshold, at least one of a time window, priority score, and delivery platform of the delivered information unit is adjusted based on the comparison. The adjusted information unit may then be delivered to the user according to the adjusted parameters. If the feedback score is equal to or higher than the predetermined threshold, the information delivering mechanism is arranged to deliver a next information unit in the sequence

In some embodiments, if the feedback score is lower than the predetermined threshold, the information delivering mechanism is arranged to deliver a previous information unit in the sequence.

In some embodiments, the received feedback is compared against reference data in order to obtain the feedback score. For example, data received from eye-tracking device could be compared to stored reference data in order to determine if the received eye-tracking data matches a pattern. Comparing received data with reference data in this way could be used for a number of different types of feedback data.

The adjustment mechanism 160 is arranged to adjust at least one of a time window, a score, and a delivery platform associated with the delivered information unit based on a result of the evaluation and comparison performed at the feedback evaluation mechanism 150. The initial defined set of information units and their associated parameters may be refined by adjusting one of: the pace that information or instruction is being delivered to the user, the time for delivering information or instruction to the user, the score of priority assigned to a certain unit information unit. The adjustment mechanism 160 may perform the adjustments by taking into account of factors relating to the absorption-level of the user.

Factors relating to the absorption-level of the user may change over time due to various reasons (especially moments that potentially trigger a relapse in the patient's condition) and these factors also serve as input to dynamically determine the new trajectory including the unit of information, the style of information and the moment of information delivery.

According to another embodiment of the present invention, system 10 comprises an information receiving mechanism 120 alone (i.e. without feedback receiving mechanism), which is arranged to receive patient information comprising a plurality of information units and at least one sequence for delivering the plurality of information units to the user.

The patient information comprises a plurality of information units and at least one sequence for delivering the plurality of information units to the user, wherein each information unit is associated with at least one of instructional and informational information, and in the sequence each information unit is associated with at least one of a time window for delivering the information unit and a priority score representing the priority for delivering the information unit.

The patient information may comprise a plurality of information units to be delivered to the user during his stay at a hospital and/or during his recovery at home after being discharged from the hospital. The patient information may be extracted from one of: an education package, an admission reason, a discharge diagnosis, a pending medical test, a result of a medical test, a result of a surgery, a procedure of a surgery, a required medical test, a required blood test, a referral to other agency or service, a list of medications, a dosage of a medication, a time of a medication, a frequency of a medication, a prescription, an order pain medication, pain management, a follow-up medical appointment, an activity restriction, a diet plan, a weight monitoring plan, a fluid requirement, wound care information, a sign of infection, a condition to call a physician, a condition to return to a hospital.

In this embodiment, each information unit comprises at least one of instructional and informational information, and in the sequence each information unit is associated with at least one of: an order of the information unit in the sequence, a priority score representing the priority for delivering the information unit, a presentation format for delivering the information unit, and a time window for delivering the information unit.

The order in the sequence, the priority score, the presentation format, and/or the time window for each of the information units in each of the sequences may be calculated based on the at least one of: a relative complexity of the information unit among all information units in the sequences, a relative cognitive difficulty for the user to understand the instructional or informational information of the information unit among all the information units in the sequences, and a relative physical difficulty of the user for following the instructional information of the information unit among all the information units in the sequences.

The time window associated with the information unit may be determined according to the period of time to which the information unit should be understood by the user according to accepted, de-facto limits in hospital admission periods. These values may be defined by a clinical expert and serve as a template for use during treatment, whereby adaptations are made to these time periods and the order with which units of information are delivered. Other sensor data and contextual information may also be used to determine the most appropriate time or time frame to deliver information or instruction to the user.

The priority score representing the priority for delivering the information unit may be determined according to the sequence in which instructions or pieces of information should be provided to the user. The priority score may be representative of severity if the instruction is not followed or incorrectly followed. The priority score may be on a scale of 1 to 10, or other scales which would allow efficient calculation and evaluation. The priority score may be linked to the risk of fatality of the user. The priority score may be calculated based on at least one of: a complexity of the information unit, a cognitive difficulty for the user to understand at least one of instructional or informational information of the information unit, and a physical difficulty for the user to perform or follow the instructional information of the information unit.

In this embodiment, system 10 comprises a recovery parameter determination mechanism (not shown in the drawings) arranged to receive data related to a recovery parameter of the user.

In this embodiment, system 10 comprises an information delivering mechanism 180 arranged to deliver at least one of the plurality of information units according to at least one of its order, priority score, presentation format, and time window.

In this embodiment, the data related to a recovery parameter of the user is at least one of: an effectiveness of a previously delivered information unit, a rate of improvement of the user, a side effect experienced by the user, physical mobility of the user, cognitive awareness of the user, an ability to process an information unit of the user, self-efficacy of the user, pain and/or discomfort experienced by the user, and sensitivity to relapse of the user.

The cognitive awareness of the user may be measured by utilizing an EEG eye tracker during the delivery of an information unit, or measured using a quiz designed to test the understanding of the user of the instructional and/or informational information of a delivered information unit. The level of digestion/understanding of information during the delivering of information and/or instruction may be measured. This may be measured by talk-back, health-literacy, etc.

The data related to recovery parameter may further include electroencephalography EEG and/or eye-tracking data, which are indicative of the user's attentiveness.

The recovery parameter may be detected using a sensor mechanism (not shown in the drawings). The sensor mechanism may be a sensor attached in the environment of the patient for tracking at least one of the recovery parameters. For example, the physical mobility of the user may be detected using a gyroscope that is worn by the user.

The sensor mechanism may be at least one of a plurality of medical and/or non-medical devices, such as weighting scales, medication dispenser, insulin pen, etc.

The recovery parameter may be input using a user interface (not shown in the drawings) employed at system 10 to allow the user to express how they feel during and/or after a course of treatment, or during and/or after a certain information unit has been delivered.

The recovery parameter may be received by tracking the user's ability and/or awareness in cognitive function and understanding for self-treatment using a user interface (not shown in the drawings) employed at system 10.

The recovery parameter determination mechanism is arranged to receive data related to recovery of the user. In particular, the recovery parameter determination mechanism is arranged to receive data related to a recovery parameter of the user. During and/or after treatment within the hospital, a clinical professional may use the data related to recovery of the user to tailor a projected recovery timeline in accordance with a treatment plan created by the clinical professional.

The data related to a recovery parameter may be further used to determine whether a predetermined condition set by a clinical professional is fulfilled by the user. For example, if the physical mobility of the user is determined to be lower than a predetermined threshold, an alarm would be issued by the system in order to alert that the user has a high possibility of relapse.

Or, as another example, if it is determined that an instruction contained in a delivered information unit has not been followed by the user (e.g. a medication dispenser detecting that medication has not been taken by the user within a preset time window), then an alarm would be issued by the system to alert a clinical professional or the user.

In this embodiment, system 10 comprises an evaluation mechanism (not shown in the drawings) arranged to determine whether adjustment is required for at least one of: the order, the priority score, the presentation format, and the time window of at least one of the plurality of information units, based on the data received by the recovery parameter determination mechanism. System 10 also comprises an adjustment mechanism 160 for performing an adjustment of at least one of: an order, a priority score, a presentation format, and a time window of at least one of the plurality of information units based on the results of the determination of the evaluation mechanism.

For example, the evaluation mechanism may determine that the user has a slow recovery due to a detected low physical mobility using the data related to a recovery parameter of the user. The adjustment mechanism may then be arranged so as to lower the priority score of at least one of the plurality of information units which is related to instructions for exercising, checking the user's weight, etc.

As another example, the evaluation mechanism may determine that there is a high risk of relapse for one of the plurality of information units if the instruction or information contained in the information unit is not followed. The adjustment mechanism may then increase the priority score of said information unit so as to ensure the user receives the instruction or information effectively.

The adjustment of priority score of an information unit may also take into account whether an instruction of the information unit is dependent on other information and/or instruction of other information unit(s).

As yet another example, the evaluation mechanism may determine that the user has a low cognitive awareness using the data related to a recovery parameter of the user. The adjustment mechanism may then adjust the presentation format of at least one of the plurality of information units in a way such that the information and/or instruction contained in the information unit(s) is easier to understand. This may be to increase the size of the text of the information and/or instruction to be delivered to the user.

By monitoring the recovery parameter(s) of the user and dosing information unit(s) accordingly by adjusting the order, priority, presentation, and/or time-delivery, the instruction and/or information can be delivered to the user according to an optimum recovery pathway so as not to overload the user with too much information.

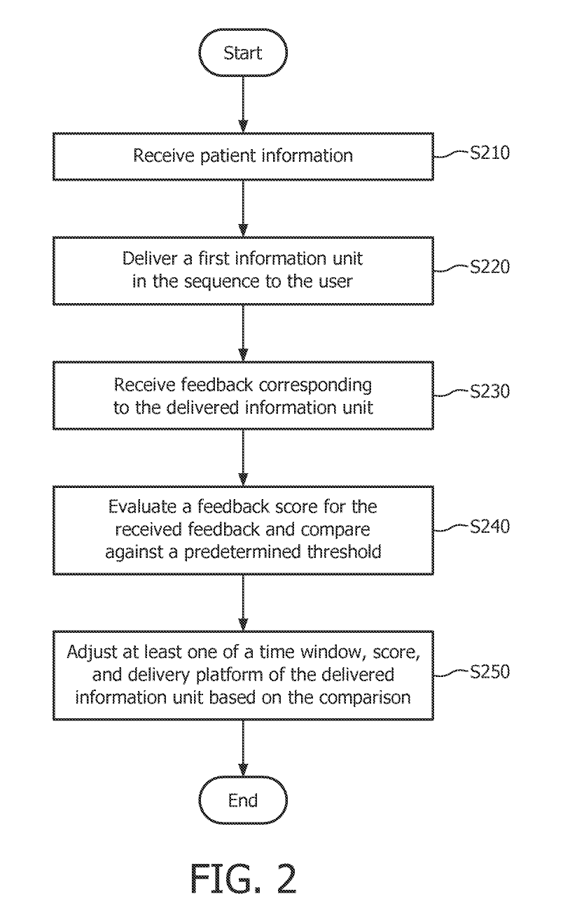

FIG. 2 shows a flow diagram explaining the operation of the system 10 according to an embodiment of the present invention.

At step S210 of FIG. 2, the system 10 receives patient information. Specifically, the information receiving mechanism 120 of the system 10 receives the patient information comprising a plurality of information units and at least one sequence for delivering the plurality of information units to the user, wherein each information unit is at least one of instructional and informational information, and in the sequence each information unit is associated with at least one of a time window for delivering the information unit, and a priority score representing the priority for delivering the information unit.

Alternatively, in another embodiment of the present invention the system modularizes the information and/or instructional information contained in the received patient information into information units. Also, in this embodiment or in yet another embodiment of the present invention, the system derives a sequence from the received patient information. Specifically, a sequence may be based on at least one of information contained in the received patient information, instructions provided by a physician, and information provided by the user. The sequence may also be a sequence received from an external source at the information receiving mechanism 120.

The time window associated with the information unit may be determined according to the period of time to which the information unit should be understood by the user according to accepted, de-facto limits in hospital admission periods. These values may be defined by a clinical expert and may serve as a template for use during treatment, whereby adaptations are made to these times periods and the order with which units of information are delivered. Other sensor data and contextual information may also be used to determine the most appropriate time or time frame to deliver information or instruction to the user.

The score representing the priority for delivering the information unit (herein referred to as “priority score” may be determined according to the sequence in which instructions or pieces of information should be provided to the user. The score may be representative of severity if the instruction is not followed or incorrectly followed. The score may be on a scale of 1 to 10. The score may be linked to the risk of fatality of the user.

The delivery platform for delivering the information unit may be determined based on one of: the assessed medical status, the information delivery mechanism available, and information and/or instruction to be given to the user. The delivery platform may correspond to the information delivery unit 170 of system 10. In other words, in certain embodiments of the present invention, the information delivery unit 170 of system 10 may be the delivery platform used to deliver an information unit to the user. In other embodiments of the present invention, the information delivery unit 170 may be used to transmit an information unit to an external delivery platform for conveying an information unit to the user.

Each information unit may also be assigned with a category according to the nature of the instruction of information.

A sequence of information units may be denoted in an exemplary format of “unit1[time, score, platform]->unit2[time, score, platform]->unit3[time, score, platform]”. This particular example indicates that a first information unit (unit1) is to be delivered first, followed by the second information unit (unit2) and third information unit (unit3) subsequently, depending on their time window, priority score, and delivery platform. Other formats of sequences may be used.

At step S220, the system 10 delivers a first information unit in the sequence to the user. Specifically, the information delivery unit 170 of system 10 delivers the first information unit to the user via a delivery platform. The delivery platform may be realized as information delivery unit 170 of system 10 in certain embodiments.

The delivery of the information unit may be in one of the following formats: textual delivery, audio delivery, video delivery, touch tablet, interactive e-learning, verbal delivery from a care giver and reminder scheduler. The method of delivering the information unit may be selected based on at least one of: the assessed medical status, the information delivery mechanism available, and information and/or instruction to be given to the user. The information delivery unit for a certain information unit may be selected based on one of: the assessed medical status, the information delivery mechanism available, information provided by a physician, information provided by the user, and information and/or instruction to be given to the user.

At step S230, feedback corresponding to the delivered information unit is received at the system, in particular at the feedback receiving mechanism. The feedback may be received directly from the user or from a data source. The data source may be connected to the feedback receiving mechanism 130. The feedback may be data related to at least one of the attention and time of the user takes to process an information unit. The feedback receiving mechanism 130 may be realized as an attention-span monitor or an adaptive learning test, e.g. questionnaire.

The feedback received at the feedback receiving mechanism 130 or the input mechanism 100 may be at least one of: time data, eye-tracking data, page scroll data, frequency with which a delivery platform is used, gyroscope data of a delivery platform, and accelerometer data of a delivery platform. The eye-tracking data may be indicative of at least one of the user's focus on an area of the delivered information unit, and the user's focus on an area of the delivery platform (e.g. an area of the screen of a tablet), and the amount of time the user spends looking at a certain page or an area of the delivered information unit or delivery platform.

The feedback may be received from at least one of: manually entered information from the user, manually entered information from a physician, an eye-tracking device, a camera, a weighing scale, an accelerometer, a gyroscope, a web-browser, a web-based application. The feedback may be received from a health-monitoring device that is connected to the input 110 or information receiving mechanism 120 of system 10.

Subjective and objective data about the information-absorption level of the user may be obtained via an attention-span monitor and adaptive learning test, etc. The feedback may be a user response to a question contained in a set of interactive instructions or a questionnaire or a form or a randomized quiz or a web-based application. Whilst in the hospital, such measurements can be reliably taken and can serve as predictor for possible future events that may influence absorption (e.g. based on a statistical model developed over time).

The adaptive learning test, interactive instructions, questionnaire, form, randomized quiz, etc. may be designed based on at least one of: a priority score representing the priority for delivering one of the information units in the sequence, information provided by a physician, information provided by the user, and previously received feedback data at the system. The adaptive learning test, interactive instructions, questionnaire, form, randomized quiz, etc. may be received from an external source at information receiving mechanism 120. The adaptive learning test, interactive instructions, questionnaire, form, randomized quiz, etc. may be stored in datastore 190.

The level of digestion/understanding of information during the delivering of information and/or instruction may be measured. This may be measured by talk-back, health-literacy, etc.

The attention of the user while they are receiving information or instructions may be monitored via eye-tracking via a front-facing camera of the information delivery mechanism. For example, the information delivery mechanism may be a tablet computer with a front-facing camera which tracks the eye movement of the user while the user is receiving information or an instruction.

The attention of the user while they are receiving information or instructions may also be monitored by measuring at least one of: the time taken by the user between page scrolls, the frequency with which the information delivery mechanism (e.g. tablet computer) is used, the motion and/or orientation of the information delivery mechanism (e.g. tablet computer) whilst being used (e.g. using gyroscope and/or accelerometer).

The feedback may also contain information from a follow-up information session held by a healthcare provider with the user regarding the transition from hospital to home. An example of feedback from such session would be the user's needs and home environment and whether he or she is more receptive to information that is personally conveyed and discussed.

At step S240, a feedback score for the delivered information unit is evaluated. The feedback received at step S230 is used to evaluate a feedback score for comparison with a predetermined threshold so as to optimize when and/or how the information unit is delivered to the unit and tailor the selection of delivery platform used for delivering information or instruction to the user. Specifically, at step S240 the efficacy of at least one of the time window, the score, and the delivery platform of the delivered information is evaluated based on efficacy statistics.

A feedback score for the delivered information unit is calculated based on the received feedback. For example, if the received feedback is eye-tracking data from an eye-tracking device installed at a computer that tracks eye movement of a user as he or she reads information presented on a page of a web-based application, the amount of time the user spends looking at a specified area (e.g. an area containing important informational and/or instructional information) on the screen may be recorded and subsequently used to calculate a feedback score. In this particular example, if the user spends 70% of the time looking at the specified area on the screen among all areas on the screen, the feedback score may be calculated as 7/10. The feedback score may be calculated using predetermined efficacy statistics. Efficacy statistics may include a predetermined scale for transforming received feedback data into quantized scores. Other algorithms and calculated methods may be used to calculate a feedback score.

The feedback score calculated in step S240 may then be compared against a predetermined threshold in order to determine whether or not at least one of a time window, priority score, and delivery platform of the delivered information unit requires adjustment. The threshold used for comparison may be associated with the particular received feedback. For example, if the feedback score calculated from a time of the user looking at a specified area on the screen is 7/10, the associated threshold for the reference/optimal time for the user looking at that specified area may be 8/10.

As an example of the operation of step S240, the feedback score may be compared with the threshold in order to determine whether the feedback score may be improved if the time window of this particular information unit is adjusted. E.g. if the calculated feedback score is 7/10 and the threshold is 8/10, it may be determined that the time window of this particular information unit would have to be increased when it is being delivered again to the user.

At step S250, at least one of a time window, priority score, and delivery platform of the delivered information unit is adjusted based on the comparison results from step S240. Specifically, the time window, priority score, and/or delivery platform of the delivered information unit may be adjusted based on a difference between the feedback score calculated at step S240 and the predetermined threshold associated with the particular information unit and/or feedback data. The initial defined set of information units and their associated parameters may be refined by adjusting one of: the pace that information or instruction is being delivered to the user, the time for delivering information or instruction to the user, the score of priority assigned to a certain unit information unit. The adjustment mechanism 160 may perform the adjustments by taking into account of factors relating to the absorption-level of the user and efficacy statistics as mentioned above.

For example, following from the above example in step S240 in which the received feedback data (eye-tracking data) is used to calculate a feedback score and the feedback score is compared against a threshold, system 10 in this embodiment may be arranged to determine whether if a time window, priority score, and delivery platform the delivered information unit is adjusted, the feedback score may be increased. Based on this determination, the adjustment mechanism 160 then performs adjustment(s) to the parameters of the delivered information unit accordingly.

Specifically, if the feedback score is lower than the predetermined threshold, at least one of a time window, priority score, and delivery platform of the delivered information is adjusted based on the comparison result. Then, the adjusted information unit may be delivered to the user.

Factors relating to the absorption-level of the user may change over time due to various reasons (especially moments that potentially trigger a relapse in the patient's condition) and these factors also serve as input to dynamically determine the new trajectory including the unit of information, the style of information and the moment of information delivery.

The method provided by the present invention allows information load to the user to be increased or decreased according to periodic checks and flagged semi-automated measures of the user using subjective and objective data (with potentially self-learning behavior) with modifications to parameters of the plurality of information units (e.g. duration).

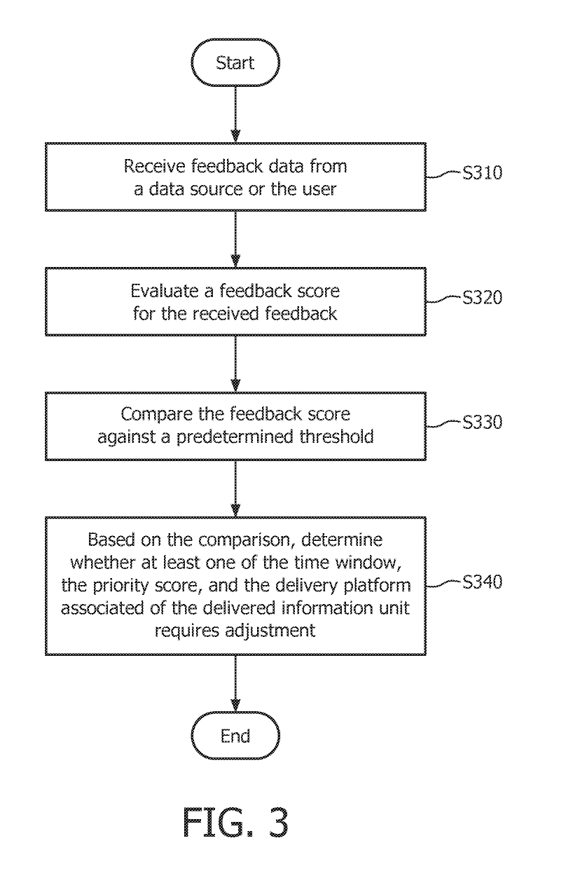

FIG. 3 shows a flow diagram explaining in detail the operation of receiving feedback and evaluating a feedback score for the received feedback and comparing the feedback score against a predetermined threshold, according to an embodiment of the present invention. The flow diagram of FIG. 3 may be considered to be a detailed explanation of the operation of steps S230 and S240.

The process starts at step S310, in which the system receives feedback data from a data source of the user. Step S310 may therefore be considered to correspond to S230 of the flow diagram of FIG. 2. The feedback may be received directly from the user or from a data source. The data source may be connected to the feedback receiving mechanism 130. The feedback may be data related to at least one of the attention and time of the user takes to process an information unit. The feedback receiving mechanism 130 may be realized as an attention-span monitor or an adaptive learning test, e.g. questionnaire.

Once feedback is received at the system, the process proceeds to step S320 in which the feedback data is quantized into a feedback score. For example, if the user spends 70% of the time looking at the specified area on the screen among all areas on the screen, the feedback score may be calculated as 7/10.

As another example, if the received feedback data relates to a question in a questionnaire and the answer may be either “yes” or “no”, a feedback score may then be straightforwardly assigned to that particular delivered information unit. In this example, if the user's answer to the question is “yes”, then a feedback score of “1” would be assigned to the delivered information unit; if the user's answer to the question is “no”, then a feedback score of “0” would be assigned to the delivered information unit.

At step S330, the calculated feedback score is compared against a predetermined threshold. For example, if the feedback score is calculated based on eye-tracking data and the feedback score is 7/10, and the predetermined threshold is 8/10, then efficacy statistics and algorithms stored in datastore 190 of system 10 may be used to determine whether the feedback score could be increased if a time window, priority score, or delivery platform of the delivered information unit was adjusted.

At step S340, at least one of a time window, priority score, and delivery platform of the delivered information unit is adjusted based on the comparison results from step S330. The initial defined set of information units and their associated parameters may be refined by adjusting one of: the pace that information or instruction is being delivered to the user, the time for delivering information or instruction to the user, the score of priority assigned to a certain unit information unit. The adjustment mechanism 160 may perform the adjustments by taking into account of factors relating to the absorption-level of the user and efficacy statistics as mentioned above.

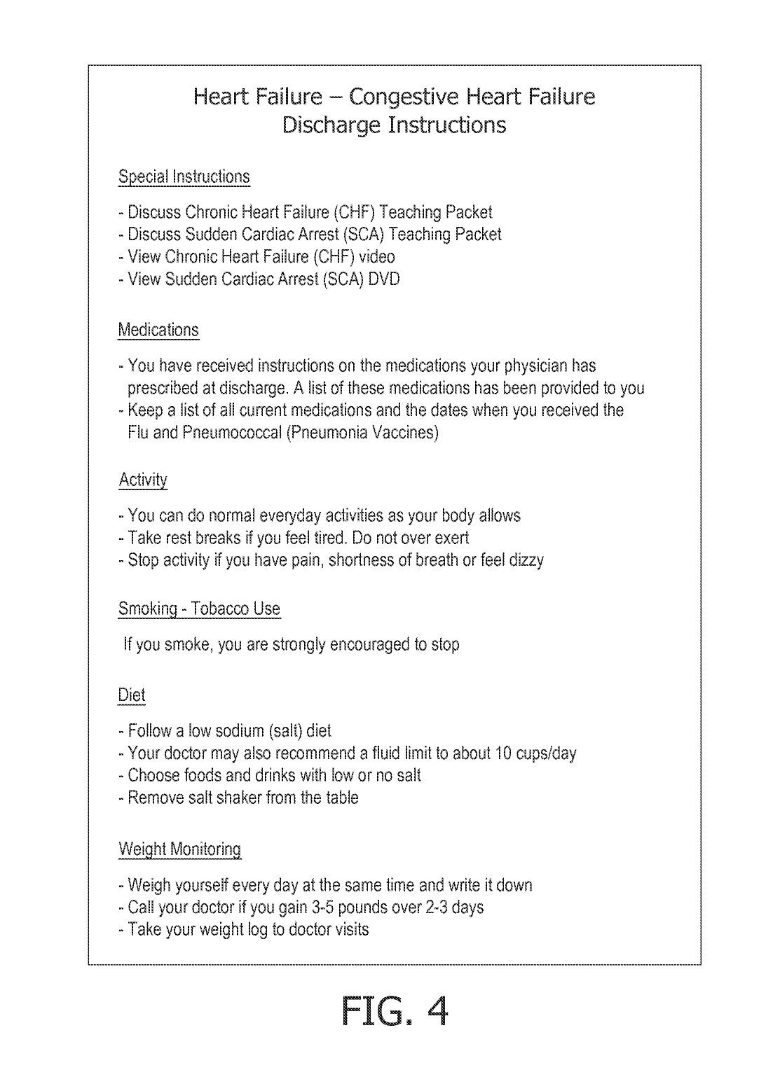

FIG. 4 is an example of patient information comprising a plurality of information units, according to an embodiment of the present invention. Specifically, FIG. 3 is a list of discharge instructions that are to be given to a patient who is suffering or suffered from congestive heart failure as he/she is being discharged from the hospital. These discharge instructions are designed to be followed by the patient at home.

The informational and instructional information contained in the sheet shown in FIG. 4 may serve as a basis for defining a sequence of information units to be delivered to the user. For example, the order of instructions listed in the sheet are as follows: special instructions containing “discuss CHF teaching packet” and “discuss SCA teaching packet” etc., medications, activity, tobacco user, diet, and weight monitoring. A sequence may therefore be defined as for example: “CHFE1” (i.e. CHF education 1)→“MI1” (i.e. medication instruction 1)→“AI1” (i.e. activity instruction 1)→“OI1” (i.e. other instruction 1)→“DI1” (i.e. diet instruction 1)→“WI1” (i.e. weight monitoring instruction 1).

As another example, a sequence may be defined based on the “special instructions” section of the sheet of FIG. 4. The defined sequence in this example may therefore be: “CHFE1” (i.e. discuss CHF teaching packet)→“SCA1” (i.e. discuss SCA teaching packet)→“CHFE2” (i.e. view CHF video)→“SCA2” (i.e. view sudden cardiac arrest DVD).

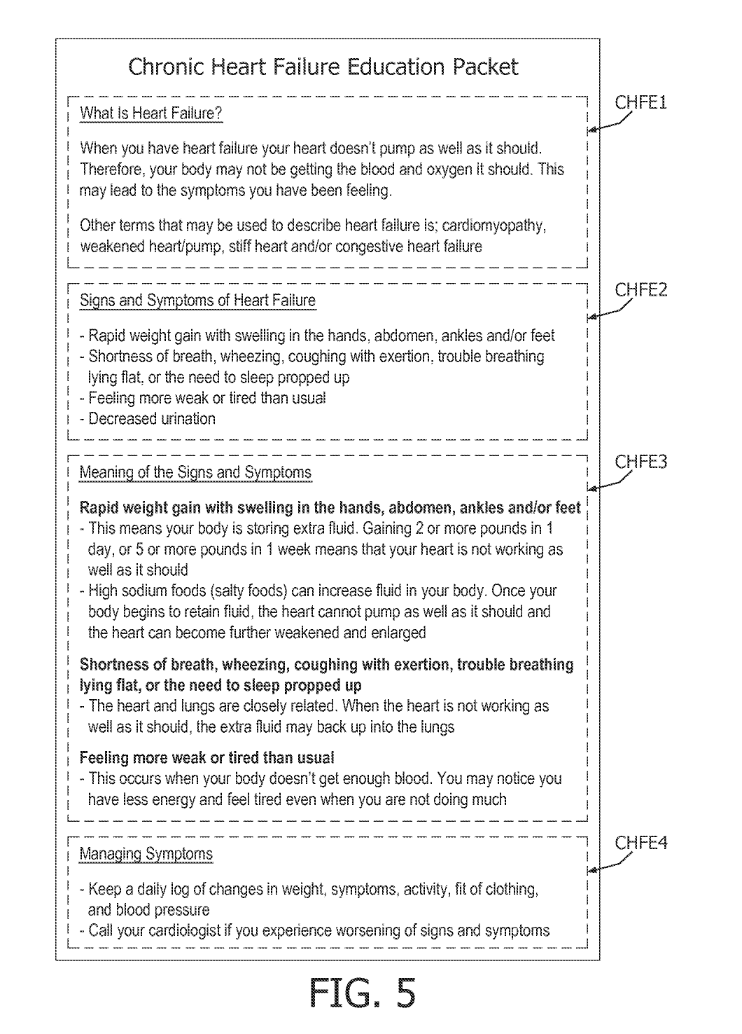

FIG. 5 shows another example of patient information which is modularized into information units according to an embodiment of the present invention. Specifically, FIG. 5 shows a sheet of “Chronic Heart Failure Education Packet” containing informational and instructional information that is modularized into 4 different information units, each relating to a diet recommendation by a hospital or a physician to a patient who suffered or is suffering from chronic heart failure.

The 4 different information units are respectively labeled “CHFE1”, “CHFE2”, “CHFE3”, and “CHFE4”. These represent respectively the first to fifth part extracted based on different sections set out in the education packet. Each of the information units CHFE1 to CHFE4 may be separately incorporated into different sequences for delivering information to the user, according to the recommendations of a physician and/or requirements/preference of the user. As shown in Table 1 above, these information units have been incorporated as part of the sequences of examples 1, 2, and 3.

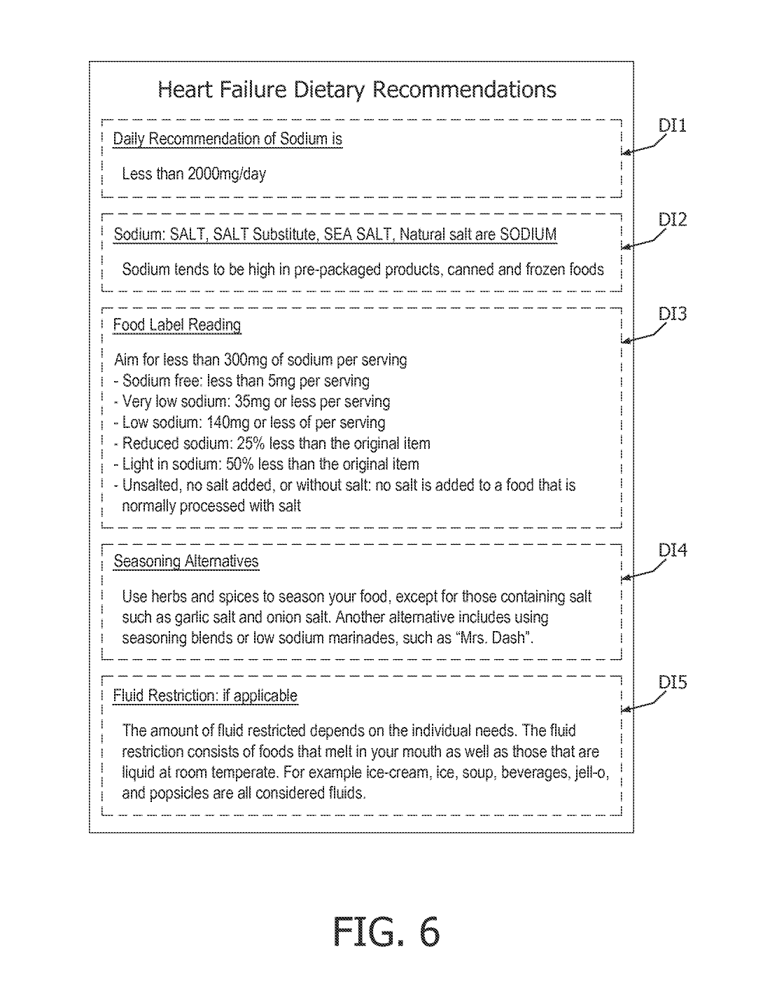

FIG. 6 shows another example of patient information which is modularized into information units according to an embodiment of the present invention. Specifically, FIG. 6 shows a sheet of “heart failure dietary recommendations” containing informational and instructional information that is modularized into 5 different information units, each relating to a diet recommendation by a hospital or a physician to a patient who suffered or is suffering from heart failure.

The 5 different information units are respectively labeled “D11”, “D12”. “D13”, “DI4”, and “DI5”. Although in this particular example, the informational and/or instructional information contained in the sheet has been modularized according to their respective sections, the informational and/or instructional information may be modularized differently in other embodiments of the present invention.

Each of the information units D11 to D15 may be separately incorporated into different sequences for delivering information to the user, according to the recommendations of a physician and/or requirements/preference of the user. For example, D11, which relates to the daily recommendation of sodium, may be incorporated in a first sequence, while D13, which relates to food label reading, may be incorporated in a second sequence in which D13 is presented in a time window associated with the meal times of the user.

Alternatively, the information units may be incorporated in a same sequence. For example, all of the information units D11 to D15 may form a sequence that may be entirely associated with diet recommendations.

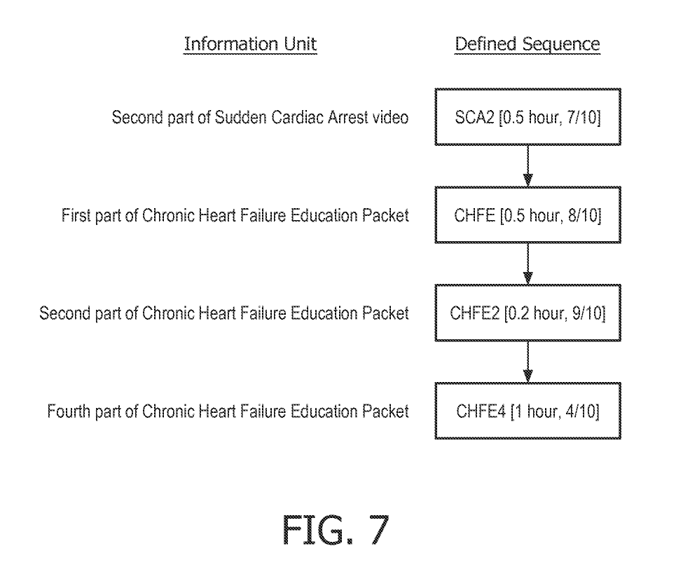

FIG. 7 shows an example of a defined sequence comprising a plurality of information units to be delivered to a user, according to an embodiment of the present invention. The sequence of FIG. 7 corresponds to the sequence as presented in example 1 of Table 1 above.

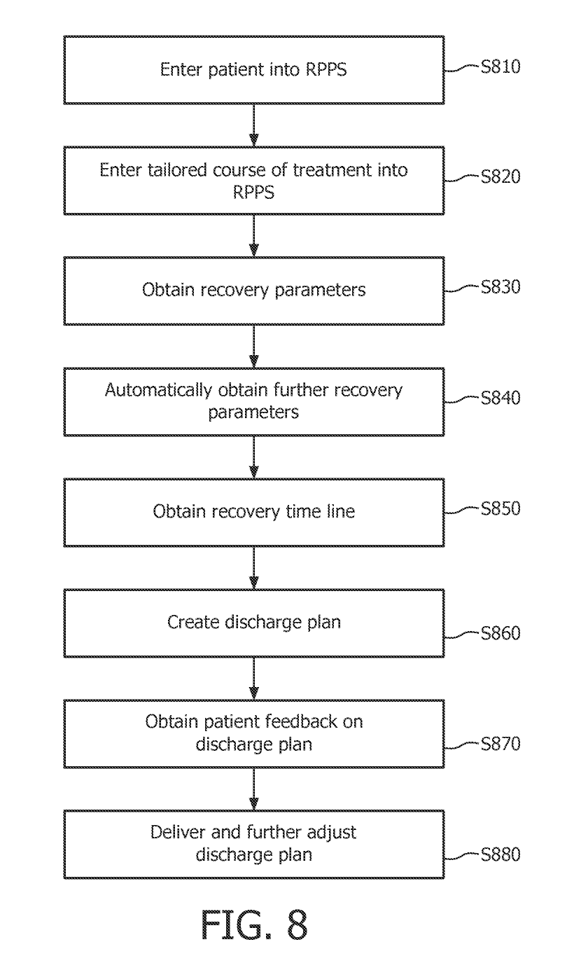

According to another embodiment of the invention, there is a provided a Recovery Pathway Planning System (RPPS). This will be described with reference to FIG. 8.

At step S810, if a patient is administered to hospital with one or more serious health conditions/injuries and a profile about the patient is entered into the Recovery Pathway Planning System. The profile includes a Pathway for the patient.

The Pathway includes the time in the hospital as well as the time the patient spends at home after discharge. Thus modularization of discharge instructions for an optimal recovery pathway is tailored from direct observation in the hospital. In particular, the information about the patient and their current ailment(s) serves as later input for tailoring discharge instructions.

At step S820, after a period of observation (depending on urgency of treatment) clinical professions will enter a tailored course of treatment(s) into the RPPS.

At step S830, the patient will receive one or more treatments whilst in hospital. The response to such treatments and their corresponding recovery parameters are manually and automatically entered into RPPS. In particular, the following recovery parameters are captured in this embodiment:

a. the effectiveness and rate of improvement of the patient with respect to the treatment(s);

b. the noted side effects observed;

c. physical mobility;

d. cognitive awareness and ability to process instructions related to self-monitoring (weight, sugar levels, infections, . . . ) and self-treatment (such as taking medication, . . . )

e. self-efficacy (e.g. eating, dressing, washing, . . . )

f. reported pain and discomfort

g. observed sensitivity to relapse

At step S840, some recovery parameters can be determined automatically by the RPPS. Automatic determination of recovery parameters are entered into the RPPS in this embodiment by:

1). Using sensors attached in the environment of the patient to track the parameters (a) to (g) mentioned above in step S830.

2). User interfaces to allow the user to express how they feel during and after the course of the treatment

3). User interfaces to track the patient's ability and awareness in cognitive function and understanding for self-treatment (e.g. utilizing an EEG eye tracker whilst presenting information about the patient's condition and the corresponding self-treatment and tracking instructions) with quizzes and questions.

At step S850, during and after treatment within the hospital, the clinical professional uses the collected information to tailor a projected recovery time-line in accordance with the treatment plan, noting and prioritizing aspects relating to the automatically generated projection.

For example, in this embodiment this could be achieved by a tool in which the clinical professional can drag the handles along a projected curve and can annotate them with conditional priorities (e.g. if the patient is below the line, then an alarm should be issued by the tool that the patient is in relapse). This projection can include the remaining period within the hospital and the remaining recovery that will take place at the patient's home. The recovery time-line uses historical information from similar patients and ailments to refine the recovery time-line.

At step S860, at the point where the patient is observed to be recovering, a discharge instruction plan is initialized via the RPPS. This plan is a series of instructions that are generated automatically from a template of single instructions pertaining to one or more treatments and diseases during discharge. Based on the sensitivity of the patient, and based on the recorded information in (a)-(g) as inputs, the order, priority, presentation and time-delivery of the instructions are uniquely tailored to that patient.

The order can be tailored based on the different rates of recovery over parameters a to g in step S830. For example, if a particular patient is projected to be very slow to recover regarding mobility, then leave instructions related to exercise, checking weight, etc, to a later phase.

The priority of an instruction to be followed can based on the relative chance of relapse if the instruction is not followed. This will depend on historical data of prior relapse as well as patient specific information collected in step S840. The priority of an instruction to be followed can based on (either additionally or alternatively to the relative chance of relapse if the instruction is not followed) the dependency of a particular instruction

The presentation of the instructions can be based on, using 3d as input, the size of the text can be made larger and the illustrations simplified and repeated for patients who find it difficult to process detailed information

The time-delivery of the instructions may vary as follows. The UI is generated such that certain instructions are delivered at certain stages in the recovery. In conjunction with this, the usage of certain (medical) devices that the patient is expected to use in conjunction with executing such instructions (weighing scales, medication dispenser, insulin pen, . . . ) is also tracked to see how the instruction delivery correspond to their execution.

At step S870, before discharge, the patient is already asked to process the discharge instructions via a user interface for a period of time in the hospital setting. Based on the feedback of the user (using the same methods as 3) in step S840 and S880), the instructions are tailored (according to step S860) before final delivery for discharge.

At step S880, the patient receives discharge instructions via a user interface that can also track the progress of understanding and conducting the instructions (when appropriate, tracking patients attentiveness via EEG and eye-tracking). The instructions are delivered (dosed) according to the projected recovery pathway so as not to overload the patient with too much information. If the detected execution of the plan does not correspond to the projected discharge instruction plan, the RPPS will send alarms to the clinical professional based on the condition described in step S850.

The execution of the instructions and their understanding of them by the patient are monitored via the user interface, via a plurality of sensors attached in the patient's environment and by medical devices that the patient is expected to use during the discharge period that can track their usage according to the time where they are expected to be used.

If the patient scores high during the hospital part of the treatment in (d in step S830), then more instructions can be delivered to the patient at an earlier phase to prepare them.

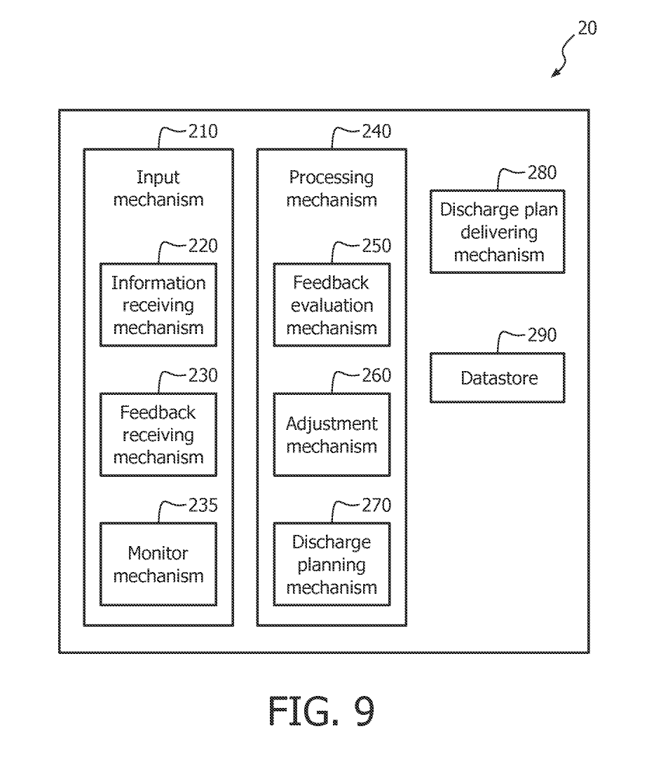

FIG. 9 schematically shows a system for adapting the delivery of information to a patient recovering from a health condition according to an embodiment of the present invention.

In FIG. 9, system 20 comprises an input mechanism 210, an information receiving mechanism 220, a feedback receiving mechanism 230, a monitor mechanism 235, a processing mechanism 240, a feedback evaluation mechanism 250, an adjustment mechanism 260, a discharge planning mechanism 270, a discharge plan delivering mechanism 280, and a datastore 290. The various mechanisms (or units) can, in some embodiments, by provided by a single device (e.g. a single unit) or by a set of devices (e.g. a set of units). The functions of elements discussed previously (e.g. in relation to FIG. 1) will not be discussed again, for the sake of convenience.

The system 20 could be used in the method discussed above in relation to FIG. 8.

The information receiving mechanism 220 receives patient information reacted to the patient while in hospital, and the monitor mechanism 235 monitors the patient while in hospital (e.g. via appropriate patient sensors). Based on this, steps S810-S830 can be carried out.

Steps S850 and S860 could be carried out by the discharge planning mechanism 270. Steps S870 and S880 could be carried out in combination by the feedback receiving mechanism 230, processing mechanism 240, feedback evaluation mechanism 250, and the adjustment mechanism 260.

Based on the above, embodiments, of the invention can provide a system for adapting the delivery of information to a patient recovering from a health condition, comprising a monitor mechanism arranged determine recovery parameters relating to treatments received by the patient, the recovery parameters being indicative of the progress of the patient's recovery; an discharge planning mechanism arranged to determine a discharge plan for the patient based on the recovery parameters, the discharge plan comprising a plurality of information units and at least one sequence for delivering the plurality of information units to the user, wherein each information unit is at least one of instructional and informational information, and in the sequence each information unit is associated with at least one of a time window for delivering the information unit and a priority score representing the priority for delivering the information unit; a discharge plan delivering mechanism arranged to deliver a first information unit in a first sequence of the discharge plan to the user via a delivery platform; a feedback receiving mechanism arranged to receive feedback corresponding to the delivered information unit; a feedback evaluation mechanism arranged to calculate a feedback score for the received feedback; a processing mechanism arranged to compare the feedback score with a predetermined threshold, wherein if the feedback score is lower than the predetermined threshold, an adjustment mechanism is arranged to adjust at least one of a time window, score, and delivery platform of the first delivered information unit based on a result of the comparison and the information delivering mechanism is arranged to deliver the adjusted first information unit, and if the feedback score is equal to or higher than the predetermined threshold, the information delivering mechanism is arranged to deliver a next information unit in the first sequence.

As discussed, embodiments of the invention can provide a system for adapting the delivery of information to a user, the system comprising: an information receiving mechanism arranged to receive patient information comprising a plurality of information units and at least one sequence for delivering the plurality of information units to the user, wherein each information unit is at least one of instructional and informational information, and in the sequence each information unit is associated with at least one of a time window for delivering the information unit and a priority score representing the priority for delivering the information unit; an information delivering mechanism arranged to deliver a first information unit in a first sequence to the user via a delivery platform; a feedback receiving mechanism arranged to receive feedback corresponding to the delivered information unit; a feedback evaluation mechanism arranged to calculate a feedback score for the received feedback; a processing mechanism arranged to compare the feedback score with a predetermined threshold, wherein: if the feedback score is lower than the predetermined threshold, an adjustment mechanism is arranged to adjust at least one of a time window, score, and delivery platform of the first delivered information unit based on a result of the comparison and the information delivering mechanism is arranged to deliver the adjusted first information unit, and if the feedback score is equal to or higher than the predetermined threshold, the information delivering mechanism is arranged to deliver a next information unit in the first sequence.

Embodiments of the invention can also provide a method for adapting the delivery of information to a user, the method comprising: receiving patient information comprising a plurality of information units and at least one sequence for delivering the plurality of information units to the user, wherein each information unit is at least one of instructional and informational information, and in the sequence each information unit is associated with at least one of a time window for delivering the information unit and a priority score representing the priority for delivering the information unit; delivering a first information unit in a first sequence to the user via a first delivery platform; receiving feedback corresponding to the delivered information unit; evaluating a feedback score for the received feedback; comparing the feedback score with a predetermined threshold; and if the feedback score is lower than the predetermined threshold, adjusting at least one of a time window, priority score, and delivery platform of the delivered first information unit based on a result of the comparison and delivering the adjusted first information unit, or if the feedback score is equal to or higher than the predetermined threshold, delivering a next information unit in the first sequence.

It will be appreciated that the hardware used by embodiments of the invention can take a number of different forms. For example, all the components of the system could be provided by a single device (e.g. the example of FIG. 1), or different components of the system could be provided on separate devices. More generally, it will be appreciated that embodiments of the invention can provide a system that comprises one device or several devices in communication.

It will be appreciated that the term “comprising” does not exclude other elements or steps and that the indefinite article “a” or “an” does not exclude a plurality. A single processor may fulfill the functions of several items recited in the claims. The mere fact that certain measures are recited in mutually different dependent claims does not indicate that a combination of these measures cannot be used to an advantage. Any reference signs in the claims should not be construed as limiting the scope of the claims.

Although claims have been formulated in this application to particular combinations of features, it should be understood that the scope of the disclosure of the present invention also includes any novel features or any novel combinations of features disclosed herein either explicitly or implicitly or any generalization thereof, whether or not it relates to the same invention as presently claimed in any claim and whether or not it mitigates any or all of the same technical problems as does the parent invention. The applicants hereby give notice that new claims may be formulated to such features and/or combinations of features during the prosecution of the present application or of any further application derived therefrom.

1. A system for adapting the delivery of information to a user, the system comprising:
an information receiving mechanism arranged to receive patient information comprising a plurality of information units and at least one sequence for delivering the plurality of information units to the user, wherein each information unit is at least one of instructional and informational information, and in the sequence each information unit is associated with at least one of a time window for delivering the information unit and a priority score representing the priority for delivering the information unit;
an information delivering mechanism arranged to deliver a first information unit in a first sequence to the user via a delivery platform;
a feedback receiving mechanism arranged to receive feedback corresponding to the delivered information unit;
a feedback evaluation mechanism arranged to calculate a feedback score for the received feedback;
a processing mechanism arranged to compare the feedback score with a predetermined threshold, wherein
if the feedback score is lower than the predetermined threshold, an adjustment mechanism is arranged to adjust at least one of a time window, score, and delivery platform of the first delivered information unit based on a result of the comparison and the information delivering mechanism is arranged to deliver the adjusted first information unit, and
if the feedback score is equal to or higher than the predetermined threshold, the information delivering mechanism is arranged to deliver a next information unit in the first sequence.

2. The system of claim 1, wherein the received patient information comprises a plurality of sequences for delivering information units, and the information delivering mechanism is arranged to deliver a second information unit in a second sequence via a second delivery platform, further wherein the priority scores associated with the first information unit and the second information unit are used to determine the priority for delivering the first information unit and the second information unit.

3. The system of claim 1, wherein the predetermined threshold is a reference score associated with the received feedback.

4. The system of claim 1, wherein the adjusting at least one of a time window, priority score, and delivery platform the delivered information unit is based on a difference between the feedback score and the predetermined threshold.

5. The system of claim 1, wherein the priority score is calculated based on the at least one of a complexity of the information unit, a cognitive difficulty of the user to understand the instructional or informational information of the information unit and a physical difficulty of the user for following the instructional information of the information unit.

6. The system of claim 2, wherein the priority score of each of the information units in each of the sequences is calculated based on the at least one of a relative complexity of the information unit among all information units in the sequences, a relative cognitive difficulty for the user to understand the instructional or informational information of the information unit among all the information units in the sequences, and a relative physical difficulty of the user for following the instructional information of the information unit among all the information units in the sequences.

7. The system of claim 1, wherein the priority score for delivering the information unit is taken into account when determining at least one of: when the information is delivered, how the information is delivered, and importance of the informational or instructional information of the information unit.

8. The system of claim 1, wherein the information delivering mechanism is arranged to deliver the first information unit according to at least one of the time window, the score, and the delivery platform associated with the first information unit.

9. The system of claim 1, wherein the feedback contains information relating to at least one of: medical data of the user, recommended treatment for the user, interaction data between the user and a healthcare provider, an attention level of the user required to process the delivered information unit, a time period the user required to process the delivered information unit, concentration level of the user, cognitive level of the user, lifestyle preference of the user, personal preference of the use, cultural needs of the user, emotional needs of the user, social needs of the user, health literacy of the user, medical history of the user, psychological state of the user, emotional state of the user, readmission history of the user, location of the user.

10. The system of claim 1, wherein the feedback is received from at least one of: manually entered information from the user, manually entered information from a physician, an eye-tracking device, a camera, a weighing scale, an accelerometer, a gyroscope, a web browser

11. The system of claim 9, wherein the form, questionnaire, randomized quiz, or web-based application associated with the delivered information unit is designed based on at least one of a time window, delivery platform, and priority score of at least one of the information units in the sequence.

12. The system of claim 1, wherein evaluating of the feedback score is based on at least one of a: preference of the user to the delivery platform; a percentage of correct answers in a randomized quiz, time taken to read a page of information before it is changed, information provided by a health care professional associated with the delivery of the first information unit, sensor data associated with the delivery of the first information unit.

13. The system of claim 1, wherein if the feedback score is lower than the predetermined threshold, the information delivering mechanism is arranged to deliver a previous information unit in the first sequence.

14. A system according to claim 1, wherein the user is recovering from a health condition is, the system further comprising:
a monitor mechanism arranged determine recovery parameters relating to treatments received by the user, the recovery parameters being indicative of the progress of the user's recovery;
an discharge planning mechanism arranged to determine a discharge plan for the user based on the recovery parameters, the discharge plan comprising said plurality of information units.

15. A method for adapting the delivery of information to a user, the method comprising:
receiving patient information comprising a plurality of information units and at least one sequence for delivering the plurality of information units to the user, wherein each information unit is at least one of instructional and informational information, and in the sequence each information unit is associated with at least one of a time window for delivering the information unit and a priority score representing the priority for delivering the information unit;
delivering a first information unit in a first sequence to the user via a first delivery platform;
receiving feedback corresponding to the delivered information unit;
evaluating a feedback score for the received feedback;
comparing the feedback score with a predetermined threshold; and
if the feedback score is lower than the predetermined threshold, adjusting at least one of a time window, priority score, and delivery platform of the delivered first information unit based on a result of the comparison and delivering the adjusted first information unit, or
if the feedback score is equal to or higher than the predetermined threshold, delivering a next information unit in the first sequence.

16. The method of claim 15, wherein the received patient information comprises a plurality of sequences for delivering information units, and the method further comprises delivering a second information unit in a second sequence via a second delivery platform, further wherein the priority scores associated with the first information unit and the second information unit are used to determine the priority for delivering the first information unit and the second information unit.

17. The method of claim 15, wherein the predetermined threshold is a reference score associated with the received feedback.

18. The method of claim 16, wherein the adjusting at least one of a time window, priority score, and delivery platform the delivered information unit is based on a difference between the feedback score and the predetermined threshold.

19. A system for adapting the delivery of information to a user, the system comprising:
an information receiving mechanism arranged to receive patient information comprising a plurality of information units and at least one sequence for delivering the plurality of information units to the user, wherein each information unit is at least one of instructional and informational information; and in the sequence each information unit is associated with at least one of: an order of the information unit in the sequence, a priority score representing the priority for delivering the information unit, a presentation format for delivering the information unit, and a time window for delivering the information unit;
a recovery parameter determination mechanism arranged to receive data related to a recovery parameter of the user;
an evaluation mechanism arranged to determine whether adjustment is required for at least one of: an order, a priority score, a presentation format, and a time window of at least one of the plurality of information units, based on the data received by the recovery parameter determination mechanism;
an adjustment mechanism arranged to perform an adjustment of at least one of: an order, a priority score, a presentation format, and a time window of at least one of the plurality of information units based on the results of the determination; and
an information delivering mechanism arranged to deliver at least one of the plurality of information units according to at least one of its order, priority score, presentation format, and time window.

20. The system of claim 19, wherein the recovery parameter of the user is at least one of: an effectiveness of a previously delivered information unit, a rate of improvement of the user, a side effect experienced by the user, physical mobility of the user, cognitive awareness of the user, an ability to process an information unit of the user, self-efficacy of the user, pain and/or discomfort experienced by the user, and sensitivity to relapse of the user.

21. A system for adapting the delivery of information to a patient recovering from a health condition, comprising
a monitor mechanism arranged determine recovery parameters relating to treatments received by the patient, the recovery parameters being indicative of the progress of the patient's recovery;
an discharge planning mechanism arranged to determine a discharge plan for the patient based on the recovery parameters, the discharge plan comprising a plurality of information units and at least one sequence for delivering the plurality of information units to the user, wherein each information unit is at least one of instructional and informational information, and in the sequence each information unit is associated with at least one of a time window for delivering the information unit and a priority score representing the priority for delivering the information unit;
a discharge plan delivering mechanism arranged to deliver a first information unit in a first sequence of the discharge plan to the user via a delivery platform;
a feedback receiving mechanism arranged to receive feedback corresponding to the delivered information unit;
a feedback evaluation mechanism arranged to calculate a feedback score for the received feedback;
a processing mechanism arranged to compare the feedback score with a predetermined threshold, wherein
if the feedback score is lower than the predetermined threshold, an adjustment mechanism is arranged to adjust at least one of a time window, score, and delivery platform of the first delivered information unit based on a result of the comparison and the information delivering mechanism is arranged to deliver the adjusted first information unit, and
if the feedback score is equal to or higher than the predetermined threshold, the information delivering mechanism is arranged to deliver a next information unit in the first sequence.

22. The system of claim 20, wherein the recovery parameter of the user is at least one of: an effectiveness of a previously delivered information unit, a rate of improvement of the user, a side effect experienced by the user, physical mobility of the user, cognitive awareness of the user, an ability to process an information unit of the user, self-efficacy of the user, pain and/or discomfort experienced by the user, and sensitivity to relapse of the user.
